(19) United States
(12) Patent Application Publication
(10) Pub. No.: US 2010/0234491 A1
(43) Pub. Date: Sep. 16, 2010

(54) METHOD AND MATERIAL FOR MANUFACTURING FIBER CEMENT BOARD

(76) Inventors: Morteza Khorrami, TEHRAN (IR); Eshmaiel Ganjian, TEHRAN (IR); Abolhassan Vafai, TEHRAN (IR)

Correspondence Address: CHOOBIN & CHOOBIN CONSULTANCY L.L.C;Barry Choobin, Green Community, Building 3, Ground Floor, Dubai Investment Park, P.O Box 212880, Dubai, AE

(21) Appl. No.: 12/788,390

(22) Filed: May 27, 2010

(51) Int. Cl. C08K 3/34

(52) U.S. Cl. 524/5; 524/2

(57) ABSTRACT

The various embodiments herein provide a method and materials to produce non-asbestos Fiber Cement Board (FCB). According to one embodiment herein, a new material including Cement (60%-75% by weight), Acrylic fiber (1%-4% by weight), Nano silicate (1%-4% by weight), slake lime stone powder (5%-20% by weight), waste cardboard pulp paper (3%-12% by weight) and some polymeric additives are used to make FCB in the Hatcheck process. In another embodiment, a method to make FCB using this method in the Hatcheck process, only some small changes are needed. According to another embodiment, the FCB produced in this method can be used for cladding, internal wall and external walls.

### SPONSORSHIP STATEMENT

The present invention for international filing is sponsored by The Iranian Nanotechnology initiative Council.

### BACKGROUND

1. Technical Field

The embodiments herein generally relate to a fiber cement board and particularly to a non-asbestos based Fiber Cement Board (FCB). The present invention more particularly relates to a process of manufacturing of a non asbestos based Fiber Cement Board (FCB) in a Hatcheck process.

2. Description of the Related Art

Fiber cement siding (or “fiber cement cladding” in the UK and Australasia) is a building material used to cover the exterior of a building in both commercial and domestic applications.

Fiber cement is a composite material made of filler, cement and cellulose fibers. In appearance fiber cement siding most often consists of overlapping horizontal boards, imitating wooden siding, clapboard and imitation shingles. Fiber cement siding is also manufactured in a sheet form and is used not only as cladding but is also commonly used as a soffit/eave lining and as a tile underlay on decks and in bathrooms. Siding is not only used as an exterior siding, it can also be utilized as a substitute for timber fascias and barge boards in high fire areas.

Asbestos (from Greek [symbol] meaning “unquenchable” or “inextinguishable”) is a set of six naturally occurring silicate minerals exploited commercially for their desirable physical properties. They all have in common their asbestiform habit, long, (1:20) thin fibrous crystals. The inhalation of asbestos fibers can cause serious illnesses, including malignant lung cancer, mesothelioma (a formerly rare cancer strongly associated with exposure to asbestos), and asbestosis (a type of pneumoconiosis). Since Jan. 1, 2005, the European Union has banned all use of asbestos [1] and extraction, manufacture and processing of asbestos products.

Asbestos became increasingly popular among manufacturers and builders in the late 19th century because of its sound absorption, tensile strength, and its resistance to heat, electrical and chemical damage. When asbestos is used for its resistance to fire or heat, the fibers are often mixed with cement or woven into fabric or mats. Asbestos was used in some products for its heat resistance, and in the past was used on electric oven and hotplate wiring for its electrical insulation at elevated temperature, and in buildings for its flame-retardant and insulating properties, tensile strength, flexibility, and resistance to chemicals.

In recent decades, governmental regulations have banned the use of asbestos due to its harmful effects. Therefore, attempts have been made to find replacement for asbestos. According to the results of research which have been done around the world, other fibers are not capable, without further modifications in the formulation, providing a relatively high drainage time, of forming suitable filter mat from the slurry and many problems during manufacturing. The results of some pieces of research have been published as papers and/or patents. Some of them are related to finding alternatives for asbestos fiber and others deals with improving the characteristics of fiber cement products by modification, treatment and refining of fibers. Generally, in most case, finding a fiber to replace asbestos fibers is impossible so researches focused on blending two or more types of fibers and some additives and admixtures. In this way, much attention has been channeled to the utilization of natural cellulose and synthetic fibers in cement composite board. It has also been found that various synthetic fibers, such as polyethylene, polypropylene etc. and some natural fibers cannot be used alone instead of asbestos because they will not disperse properly in the slurry solution. These fibers tend to float to the top of the slurry because they have a lower specific gravity than aqueous cement solution, and therefore they will not form a homogeneous mat on the cylinder of a wet forming machine. The result of some related researches have been pointed as follow.

A material for reinforcing cement sheet products containing fibers other than asbestos, clay and thickener have been developed, in which fiber cement product consisting essentially by weight of a Portland cement binder in the amount of between about 40% and 80%, natural and/or synthetic fibers in an amount of between 1% and 15%, clay in an amount of between about 2% and 15%, and thickener in an amount of between about 0.03% and 0.5%. The product may also contain silica and/or filler in an amount of between about 10% and 40% by weight.

Cellulosic fibers have been found to be suitable as reinforcement in fiber cement building products. Although, associated with certain problems like swelling in highly alkaline cement matrix and effects of climatic changes, the durability of cellulose fibers cement composite are correlated with the fiber type, fiber content, matrix type and aging methods. However, research has indicated that cellulose fibers at volumes ranging from 0.06% to 0.5% significantly reduce restrained drying-shrinkage cracking in cementitious materials.

A method of manufacturing a wood-cement board has been explained which uses some materials such as wood flake, fly ash and cement. In this innovation, 30 to 40% by weight of cement material, 20 to 27% by weight of wood flake, and 30 to 40% by weight of fly ash are used to prepare a raw material mixture, on a mould panel to form a mat, pressing and pre-curing said mat with moisture, and main-curing said pre-cured mat in an autoclave.

An improved process for forming a polymer-modified fiber-cement composite which exhibits improved performance in at least one of: resistance to water, freeze-thaw stability, chemical resistance, impact strength, abrasion resistance, flexural strength, tensile strength, % strain at failure, dimensional stability, interlaminar bond strength, and fiber to matrix bond strength relative to a corresponding composite absent the polymer. Further, polymer modification may permit a composite with a reduced level of fibers, advantageous because fiber is typically more expensive than cement, to give performance equal to an unmodified composite. Polymer modification may also allow equal performance from a thinner and lighter fiber-cement board, which facilitates transportation, handling and installation.

The Kraft process is the most frequently used chemical pulping method and this process entails the cooking of wood chips with a mixture of caustic soda and sodium sulphide in a digester so as to break the lining that is linking the cellulose, pulp obtained from this process is usually used to manufacture high grade papers and other high quality materials, for example the softwood unbleached Kraft are the most widely used wood fibers in cement composite due to their characteristic strength, availability and cost.

Cellulose natural fibers are found to enhance the mechanical properties of cementitious materials such as flexural strength, toughness, tensile strength, thermal shock, impact and resistance to fatigue in concrete and cementations materials.

High performance level of fiber reinforced cement products in the construction industry could lead to generation of tough and long-lasting construction materials. Natural fibers are sometimes also used in combination with synthetic fibers in cement products to improve the mechanical properties of the product for example polypropylene (PP) and polyethylene (PE) are employed in products to control cracking and improve the ductility of composite.

The effect of potassium silicate, sodium silicate and silane treatment on newspaper and unbleached Kraft fiber cement composite compared to untreated wood fiber cement composite has also been reported. Both wood fibers were chemically treated with aqueous solution. They concluded that aqueous chemical treatments enhance the mechanical properties of the treated wood fiber-cement composites.

The most successful replacement for asbestos in many of the European countries has been a combination of PVA fibers and cellulose fibers with cement using the Hatcheck process. Also in some cases, fillers such as silica or limestone powder are used (about 5-20%). Usually, curing of this type of product is in air because PVA fibers are not stable in autoclave. Generally PVA fibers can't be refined while cellulose fibers can be. The most important role of cellulose fiber in this process is aiding to form the network on the sieve cylinders that catches the solid particles in the dewatering step. This product has a good biological durability due to its high density and non-biological degradable PVA fibers. The great disadvantage of these products is a very large increase in material and manufacturing process costs. At present, the price for cellulose is about £300 per ton and PVA fiber is about £2500 per ton.

In Australia/New Zealand and the USA, one of the most successful replacements for asbestos has been the use of unbleached cellulose fibers (usually Kraft fibers), with cement (about 35%), and fine ground silica (about 55%) in the Hatcheck process. Some of the relevant patents regarding this type of cement board are Australian Patent No. 515151 and U.S. Pat. No. 6,030,447. As the cellulose fiber is stable in autoclave, most of this type of product cures in autoclave. European cement composite products are subjected to hydraulic press so they have high density and are in low workable. Also the European technology uses increased material and manufacturing costs however their quality and durability against environmental condition and biological attacks are more than the products those have made of only cellulose fibers without pressing step in production line. It means, cellulose fiber cement composite board may have some drawbacks due to highly porous and higher susceptibility to biological attacks such as lower rot resistance (or other microorganisms such as fungi, bacteria, algae, and moulds particularly in high humidity environments) and poorer long-term durability compared to the products those use PVA fibers and pressing step in manufacturing.

There are many factories around the world that produce cement composite board. Almost all of them use their own special method that is not match entirely with other factories. Some of them encounter none of the problems mentioned above and produce high quality products and some of them may have problems such as providing high drainage time, forming a suitable filter mat, problems during manufacturing, swelling in highly alkaline cement matrix, effects of climatic changes.

There are many types of cement composite board around the world. Each factory announces different values for above mention characteristics that it can be observed in their catalogues. But, the most important points are that these characteristics should be met the standards needs for each type of application. So with changing the mix proportions or using different types of admixtures and additives, some characteristics of cement composite boards such as water absorption, permeability, resistant to freezing and thawing, water movement, density, flexural strength can be different.

Hence there is a need for non-asbestos cement composite board that is more workable overcoming the drawbacks, meeting the relevant standard requirements and is cost-effective.

The above mentioned shortcomings, disadvantages and problems are addressed herein and which will be understood by reading and studying the following specification.

### OBJECTIVES OF THE INVENTION

The primary object of the embodiments herein is to provide non-asbestos based Fiber Cement Board (FCB).

Another object of the embodiments herein is to provide non-asbestos based Fiber Cement Board (FCB) for roofing, cladding, internal wall and external walls.

Another object of the embodiments herein is to provide non-asbestos Fiber Cement Board (FCB) that meets the relevant standards, mechanical and physical requirements.

These and other objects and advantages of the present invention will become readily apparent from the following detailed description taken in conjunction with the accompanying drawings.

### SUMMARY

The various embodiments herein provide non-asbestos Fiber Cement Board. The composite cement board comprising cement, a compound selected from a group of polymers, nanosilicate, slake lime stone powder, waste cardboard pulp paper and some polymeric admixtures. The compound selected from a group of polymers containing synthetic fibers is acrylic fiber.

According to one embodiment, composition comprises of a compound selected from a group of polymers containing natural or synthetic fibers, i.e. acrylic fiber. The cement composite composition, as mentioned in the present invention provides non-asbestos Fiber Cement Board.

According to one embodiment, a fiber-cement board composition which is capable of being formed on a Hatcheck machine consisting essentially of a Portland cement binder in the amount of between about 60% and 75% by weight, natural and/or synthetic fibers in an amount of between about 3% and 12% by weight, nano calcium silicate in an amount of between about 1% and 4% by weight, acrylic fibers in an amount of between about 1% and 4% by weight and lime stone powder in an amount of between about 5% and 20% by weight.

According to one embodiment of the present invention, a process of preparing non-asbestos fiber cement board is provided. The method involves selecting a compound from a group of polymers containing natural or synthetic fibers, cement, nanosilicate, slake lime stone powder, waste cardboard pulp paper and some polymeric additives to prepare composite board. The compound selected from a group of polymers containing natural or synthetic fibers is acrylic fibers. Kraft pulp is obtained from waste cardboard and acrylic fibers have been used to produce fiber cement composite board. Fibers applied are discrete and randomly oriented fibers mixed with cement, nano silicate, lime stone powder and water. All materials are mixed together using a turbo mixer and then put into the hatcheck machine. After making the samples, they are put in an oven at 50 degree of Celsius and 85% relative humidity (RH) for about 8 hours then transported to a storage space with temperature 20-25° C. and 80% RH for 27 days. After 28 days of casting, the products are ready to use.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining the process of preparing non-asbestos fiber cement board according to one embodiment of the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a composition for a cement composite board, wherein the cement composite board is non-asbestos Fiber Cement Board (FCB).

A fiber-cement board which is capable of being formed on a Hatcheck machine consisting essentially of a Portland cement binder in the amount of between about 60% and 75% by weight, natural and/or synthetic fibers in an amount of between about 3% and 12% by weight, nano calcium silicate in an amount of between about 1% and 4% by weight, acrylic fibers in an amount of between about 1% and 4% by weight and lime stone powder in an amount of between about 5% and 20% by weight.

Kraft pulp obtained from waste cardboard and acrylic fibers has been used to produce fiber cement board (FCB). Fibers applied are discrete and randomly oriented fibers are mixed with cement, Nano silicate, lime stone powder and water. All materials are mixed together in a turbo mixer and put into the hatcheck machine. After making the samples, they are put in an oven at 50° C. and 85% relative humidity (RH) for about 8 hours, and then transported to a storage space with temperature 20-25° C. and 80% relative humidity (RH) for 27 days. So 28 days after casting, the products are ready to use.

According to another embodiment of the present invention, a process of preparing a fiber cement composite board is provided. The method involves selecting a compound from a group of polymers containing natural or synthetic fibers, cement, nanosilicate, slake lime stone powder, waste cardboard pulp paper and some polymeric additives. The compound selected from a group of polymers containing synthetic fibers is acrylic fiber.

According to one embodiment, a composition for a cement composite board comprising of cement, a compound selected from a group of polymers containing natural or synthetic fibers, amorphous nanosilicate, slake lime stone powder, waste cardboard pulp paper and some polymeric admixtures.

The embodiments herein are related to a group of polymers containing natural or synthetic fibers. This group of polymers can be used for the process of preparing a non-asbestos fiber cement composite board.

The most specific substance that is focused on in this invention is Kraft pulp and acrylic fibers to produce fiber cement board. The other components required for the preparation of the fiber cement board are cement, amorphous nanosilicate, slake lime stone powder, water and some polymeric admixtures.

The current invention relates to a fiber cement sheet which does not include asbestos fiber but which contains other fibers and the blend of admixtures so as to permit satisfactory manufacture thereof on a machine in which slurry is formed on a screen and then vacuum-filtered through a felt.

In this innovation, scrap cardboard and Kraft paper, are smashed and changed to pulp in the mixer. After shredding waste cardboard, they are submerged in the water for about 2 days, and then they go to the mixer for about 4 hours to change to pulp. Wide dough blade mixer is used for this purpose. In this stage, the obtained cellulose fiber enters into refiner to fibrillate. Fibrillation (beating or refining) of fibres should be done only for cellulose fibres. It can be defined as the mechanical treatment of pulp carried out in the presence of water, usually by passing the suspension of pulp fibres through a relatively narrow gap between a revolving rotor and a stationary stator. The term ‘beating’ is usually applied to a batch treatment of pulp suspension, whereas ‘refining’ is used when the stock is passed continuously through one or more refiners in series.

Refining plays an important role in producing a large surface area for fibre-to-fibre or fibre-to-matrix bonding and, more importantly, can assist in controlling the drainage rates of processing liquids during the fabrication of products. Refining affects the hydraulic properties of the fibre effectively reducing its average diameter. In turn this affects the propensity to flocculate with itself and to trap the essentially equi-dimensional particles of cement and nano silicate fume.

Next step is blending of the refined cellulose fiber and acrylic fibers in a mixer. The refinement process can process in room temperature. Both of these fibers put in a turbo mixer and Cement, nano silicate and lime stone powder is added to this mixer to create slurry solution. The slurry is placed in oven at room temperature. After mixing, all the materials enter the Hatcheck machine and are used to produce FCB. Some of the additives such as antifoam, viscose liquid can be used according to existing condition. Other process such as cutting the edges, putting in the oven, curing in air condition and storage in the factory are similar to current process that can be used in existing fiber cement board manufactories. The outcome products can be used in internal wall, external wall, and cladding and in some condition for roofing.

Some types of solution and emulsion polymer such as Polyacrylamide in a liquid form can be used as admixtures to flocculate or coagulate materials in a liquid. Applying these types of admixtures can lead to modifying the polymeric materials particularly increasing anionic characters.

One of anionic viscosity modifiers that can be applied is Polyacrylamide viscosity modifier such as Nalco 7768. Also, other types of viscosity modifiers or flocculent agent which include hydroxyethyl cellulose and polyamines may be applied. It can improve bonds between fibres and cementitious particles, forming board on the belt and enhancing the mechanical properties of cement board.

Also, slake lime powder and nano silicate fume has an influence on decreasing the porosity of the composite. The filler slake lime powder typically has particles less than 20 microns in size.

Generally, in this innovation, a fiber-cement product which is capable of being formed on a Hatcheck machine consisting essentially of a Portland cement binder in the amount of between about 60% and 75% by weight, natural and/or synthetic fibers in an amount of between about 3% and 12% by weight, nano calcium silicate in an amount of between about 1% and 4% by weight, acrylic fibers in an amount of between about 1% and 4% by weight and lime stone powder in an amount of between about 5% and 20% by weight.

The Hatcheck process for manufacturing asbestos cement board has many stages such as preparation of asbestos fiber in the mill, mixing raw materials in the mixer, producing slurry and forming cement board on the felt. In this method, only some small changes in the first stages are needed. The most important changes that should be considered are: 1) using a container and mixer to prepare the pulp from waste cardboard; 2) Applying a refiner to fibrillate the cellulose fibers.

It involves adding a container (silo) for the fibres and a mixer with spreader blade. Also a refiner is needed to fibrillate the fibres. There are many types of refiners available in the market. It might refine the pulp before entering the pulp in to the mixer. The price for these types of refiner is different and is depend on the brand and the capacity.

As some of the waste cardboard produce bubbles during the mixing process, antifoam agents are added to ensure that the composition flows easily in the Hatcheck machine. So antifoam agents can remove all bubbles and viscosity modifier can improve from the dispersion so that consistent thickness is obtained. One of the suitable antifoam's for this aim is the silicone based defoamers. These defoamers have a silicone compound as the active component. The silicone compound consists of hydrophobic silica dispersed in silicone oil. They are suitable for both knocking down surface foam and releasing entrained air. Also the defoamer can be an acetylenic-modified polysiloxane-based defoamer or a paraffinic defoamer. Using acetylenic-modified polysiloxane-based defoamer or a paraffinic defoamer can lead to the same results.

In this process, bleached or unbleached Kraft pulp and Type I or II cement can be used. To make sure about resistance of acrylic fibre in alkaline condition, they were placed in a solution of NaOH with pH of 12 for 28 days and then the tensile testing was carried out. The results should indicate not much change in the tensile strength of the Acrylic fibres before and after submerging in alkaline solution. This test should be done for any acrylic fibre which is candidate for producing FCB. The specific gravity of the Kraft was 1.5. Some of the important properties of acrylic fiber were: average length 5 mm, average diameters about 20 μm, specific gravity 1.18, average tensile strength 0.4 GPa and 3% elongation at break.

There is a broad range of characteristics for acrylic that it is usable in cement board. It is expected that after submerging acrylic fibres in alkaline solution, the properties don't go out of the specified ranges given below:

TABLE 1
Required characteristics of acrylic fibres

| | | | Modulus | | |
|---|---|---|---|---|---|
| | | | of | Tensile | Elongation |
| | Diameter | Specific | elasticity | strength | at break |
| Fiber | (μm) | gravity | (GPa) | (GPa) | (%) |
| Acrylic | 18-21 | 1.18 | 14-20 | 0.4-1.0 | 3-5 |

All stages such as preparation of cellulose fibres (includes shredding of the waste cardboards, adding water, mixing and refining) are done at ambient temperature.

Also, blending of cellulose fibres, synthetic fibres and other materials and all processes in the Hatcheck machine are carried out at ambient temperature also.

This innovation has been designed only for the Hatcheck process.

As all materials and fibres are in the stable condition in ambient temperature, they can be used without any special temperature or pressure treatments. Only for the curing of the products during the first 10 hours after making, they should be put in a high humidity environment (more than 85% RH) and between 40-60 degrees Celsius. This is necessary for hydration of the cement. This range of temperature will give the required relevant standard properties. So the temperature should stay within this range during the first 8 hours curing. It should not go above 60° C. or below 40° C.

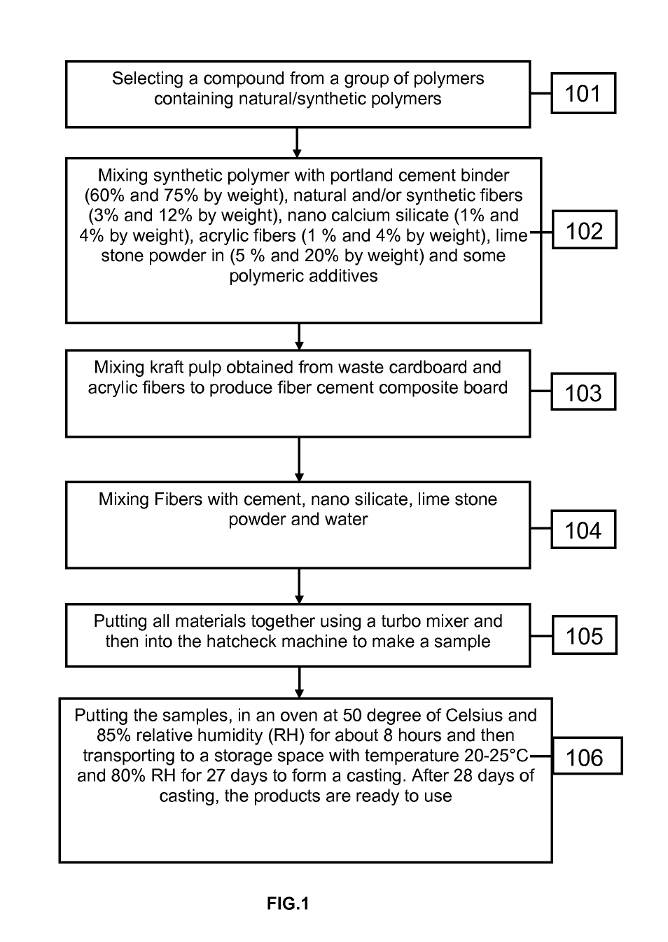

FIG. 1 illustrates a flow chart explaining the process of preparing a non-asbestos fiber cement board according to one embodiment of the embodiments herein. With respect to FIG. 1, a process of preparing non-asbestos fiber cement composite board, involves selecting a compound from a group of polymers containing natural/synthetic polymers (101). Then fiber-cement board composition consisting essentially of Portland cement binder (60% and 75% by weight), natural and/or synthetic fibers (3% and 12% by weight), nano calcium silicate (1% and 4% by weight), acrylic fibers (1% and 4% by weight) and lime stone powder in (5% and 20% by weight) (102). Kraft pulp is obtained from waste cardboard and acrylic fibers have been used to produce fiber cement composite board (103). Fibers applied are discrete and randomly oriented fibers mixed with cement, nano silicate, lime stone powder and water (104). All materials are mixed together using a turbo mixer and then put into the hatcheck machine (105). After making the samples, they are put in an oven at 50 degree of Celsius and 85% relative humidity (RH) for about 8 hours then transported to a storage space with temperature 20-25° C. and 80% RH for 27 days. After 28 days of casting, the products are ready to use (106).

After the composite cement boards are manufactured, the storage conditions in the factory should be normal condition i.e. temperature 15-30° C. and 60-95% RH.

### Experimental Data

In table-1 some examples of mix design have been presented. In this table, the weight percentage of each ingredient has been specified.

TABLE 2
four examples of mix design according to this innovation

| | | | | | Lime |
|---|---|---|---|---|---|
| | | Cellulose | Acrylic | Nano | stone |
| | Cement | fiber | fiber | silicate | powder |
| code | wt % | wt % | wt % | wt % | wt % |
| 1 | 0.685 | 0.027 | 0.017 | 0.014 | 0.068 |
| 2 | 0.719 | 0.022 | 0.014 | 0.011 | 0.036 |
| 3 | 0.725 | 0.018 | 0.011 | 0.011 | 0.036 |
| 4 | 0.678 | 0.054 | 0.000 | 0.014 | 0.068 |

There are two effects due to the addition of Nano Silicate that can increase of strengths of hardened cement paste. The first strengthening effect is the packing effect so that small particle of NS acted as filler to fill into the interstitial spaces inside the skeleton of hardened microstructure of composite. The second effects is the pozzolanic effect that combines glass-like silicon elements in NS with the lime ingredients of calcium oxide and hydroxide in cement to add the bonding strength in fibers-cement and solid volume, resulting in higher flexural of composite. Most pozzolanic reaction between the calcium hydroxide and amorphous silica (silicon dioxide) normally reacts slowly during a prolonged period of moist curing. Since the spherical particles of NS have an average particle diameter less than 100 nm which is about 500-times finer than average cement particle resulting in an extremely large surface area, the NS reacts very rapidly with the calcium hydroxide to form calcium silicate in an alkaline environment. For this reason, the contribution of added NS to the increase of strength of composite becomes apparent as early as 21 days after casting.

Slake lime particles improve modification of the composite microstructure by filling the interstitial space of composite and this material is cheaper than cement that can lead to produce the economical cement composite board. The slaked lime is also chemically reactive and enhances the pozzolanic reaction of the NS.

These improvement mechanisms of the composite attributed to the addition of NS and slake lime particles have been tested and observed by mechanical and physical tests and also doing SEM to identify microstructure of the composite.

Accordingly, the present invention introduces new materials for manufacturing cement composite board which have cost effective (because it uses waste cardboard instead of cellulose fibres and Acrylic fibres which is cheaper than PVA) and improve resistance against environmental conditions and biological attacks. (Because it applies press in the Hatcheck Process and produces high density cement composite board compare to those which use cellulose fibre solely).

The use of blended cellulose fibres and polymeric fibres, can create a desirable composite cement board on the felt in the Hatcheck process that allows the small trapped water drops to drain through the holes. Cellulose fibres have hydrophilic properties that lead to forming a layer on the felt. These materials don't create any problem in the Hatcheck machine such as damaging the felt or sticking materials in the sieve cylinders. All fibres and material are resistant in alkaline environments and the weather fluctuation doesn't affect any ingredients.

Some of the major relevant standards have been given below. As it can be seen, each standard considers different value for each of the characteristics of cement composite board according to the application required for them. For example, in the BS EN 12467 standard, the cement composite board is divided into 4 groups in respect of point flexural strength. In standard BS EN 494, there are some other classifications for cement composite board when they are exposed to moisture conditions.

Some important standards which are related to cement composite board:

BS EN 12664:2001 Thermal performance of building materials and products. Determination of thermal resistance by means of guarded hot plate and heat flow meter methods. Dry and moist products of medium and low thermal resistance

ASTM C1459-04 (2009) Standard Specification for Performance of Non-Asbestos Fiber-Reinforced Cement Shake, Shingle, and Slate Roofing Systems

ASTM C1154-06 Standard Terminology for Non-Asbestos Fiber-Reinforced Cement Products

ASTM C1185-08 Standard Test Methods for Sampling and Testing Non-Asbestos Fiber-Cement Flat Sheet, Roofing and Siding Shingles, and Clapboards

BS EN 494:2004: Fibre-cement profiled sheets and fittings. Product specification and test methods

BS EN 634-1:1995: Cement-bonded particle boards Specification General Requirements

BS EN 634-2:1997: Cement-bonded particle boards Specification Requirements for OPC bonded particleboards for use in dry, humid and exterior conditions

BS EN 12467:2004: Fibre-cement flat sheets. Product specification and test methods

The important standards (ASTM C1185-08 Standard Test Methods for Sampling and Testing Non-Asbestos Fiber-Cement Flat Sheet, Roofing and Siding Shingles, and Clapboards is the most important standard for the physical characteristics of cement composite boards. In this standard the following paragraphs are given:

Since there is no accepted reference material suitable for determining the bias for the procedure in Test Methods C 1185 for water absorption, no statement on bias is being made.

Since there is no accepted reference material suitable for determining the bias for the procedure in Test Methods C 1185 for moisture content, no statement on bias is being made.

Since there is no accepted reference material suitable for determining the bias for the procedure in Test Methods C 1185 for moisture movement, no statement on bias is being made.

Since there is no accepted reference material suitable for determining the bias for the procedure in Test Methods C 1185 for measuring flexural strength, no statement on bias is being made.

No statement is made about either the precision or bias of Test Methods C 1185 for measuring water tightness since the result merely states whether there is conformance to the criteria for success specified in the procedure

Some of standards have classification as follow. For example, according to BS EN 12467, 2004 for mechanical characteristics, only bending strength has been considered as follow:

### Physical Requirements and Characteristics

When tested as specified in BS EN 12467, the minimum modulus of rupture of the sheets, expressed in mega Pascal, shall be as specified in Table 3. The MOR shall be the average of the values obtained from testing the samples in both directions. NOTE for non-homogeneous e.g. coated sheets, Table 6 refers to the apparent MOR.
Category A and B sheet strengths are specified in the wet condition.
Category C and D sheet strengths are specified in the ambient condition.
The minimum modulus of rupture of the sheets in the weaker direction shall be not less than 70% of the specified value in Table 3 for the average of the two directions.
This requirement does not apply to textured sheets.

TABLE 3
Minimum modulus of rupture (MOR)

| | |
|---|---|
| Min. MOR in the ambient | Min. MOR in the wet |
| condition (MPa) | condition (MPa) |

| | Category A | | Category C |
|---|---|---|---|
| Classes | & B | Classes | & D |
| 1 | 4 | 1 | 4 |
| 2 | 7 | 2 | 7 |
| 3 | 13 | 3 | 10 |
| 4 | 18 | 4 | 16 |
| 5 | 24 | 5 | 22 |

NOTE 1
where manufacturers state minimum product MOR this should be at the 4% acceptable quality level (AQL).
NOTE 2
for textured sheets the MOR cannot be used for calculating mechanical performance.

NOTE 1 where manufacturers state minimum product MOR this should be at the 4% acceptable quality level (AQL).
NOTE 2 for textured sheets the MOR cannot be used for calculating mechanical performance.

Freeze-Thaw for Categories A, B and D

When tested in accordance with 7.4.1, after 100 freeze-thaw cycles for Category A and 25 cycles for Category B and D, the ratio RL as defined in 7.4.1.4 shall be not less than 0.75.

According to BS EN 494 following table has been considered for classification of cement board in view of point flexural strength.

TABLE 4
Summary of characteristics [BS EN 494]

| | | Long sheets | | | | | | |
|---|---|---|---|---|---|---|---|---|
| | | | | | Bending | | Short sheets | |
| | | | Breaking | | moment | | | Bending |
| | Height | Minimum | Load | | at rupture | | Minimum | moment at |
| | corrugations | thickness | Class 1 | Class | Class X | Class Y | thickness | rupture |
| Category | (mm) | (mm) | (N/m) | (N/m) | (N/m) | (N/m) | (mm) | (N/m) |
| A | 15 TO 30 | 4 | 1400 | 1250 | 40 | 30 | 3.5 | 25 |
| B | 25 TO 45 | 5 | 2500 | 2000 | 55 | 40 | 4 | 30 |
| C | 40 to 80 | 5.2 | 4250 | 3500 | 55 | 40 | 4 | 30 |
| D | 60 to 120 | 5.5 | 7000 | 5500 | 55 | 45 | 5 | 40 |
| E | 90 to 150 | 6 | 12500 | 8500 | 55 | 45 | | |

NOTE 1:
A special Class 3Z is allowed in Category A with a minimum individual thickness of 3.5 mm, a minimum breaking load of 750 N/m and a minimum bending moment of 20 Nm/m.
NOTE 2:
A special Class 3 with a minimum breaking load per meter width of 2 200 N/m in Category C for sheets of length greater than 0.90 m and less than 1.25 m is allowed.

Test Carried Out for Products

To identify the characteristics of the products, according to relevant standards, mechanical and physical tests have been done for the samples. The results show that the characteristics of this product are consistence with the relevant standards.

Flexural Test

Flexural test was carried out at 7 and 28 days according to BS EC 12467 standard on a JJ Lloyds Machine applying the load with a constant rate of deflection, driving at a speed of 20 mm/min. The set up includes a specimen (cement sheet) with 6-8 mm in thickness. For a rectangular specimen under a load in a three-point bending setup:

σ=3FL/(2bd²) (1)

where; F is force at the fracture point, L is length of the support span, b is width and d is thickness of the specimen.

Toughness Test

To identify the energy absorption for samples, the area under the stress-strain graph was calculated using the numerical integration method.

Moisture Movement

Moisture movement is the linear variation in length and width of test specimen, with change in moisture content. This test is used to determine the serviceability of products in areas of high humidity and exposure to moisture. Moisture movement test was carried out according to ASTM C1185. Each specimen was conditioned to practical equilibrium at a relative humidity of 30±2% and a temperature of 20±2° C. Practical equilibrium is defined as the state of time change in weight where, for practical purposes, the specimen is neither gaining nor losing moisture content more than 0.1 wt. % in a 24-h period. The length of each specimen was measured using a micrometer with the accuracy of 0.01 mm. Then the specimens were conditioned to practical equilibrium at a relative humidity of 95±5% and a temperature of 20±2° C. The lengths of the specimens were measured again. The linear change in moisture content is the percentage change in length based on the length at relative humidity change of 30 to 90 i.e.

Linear change(%)=(length at 90%−length at 30%)/(length at 30%)×100 (2)

Water Absorption

Water absorption test is done to determine the tendency of a product to absorb water and sometimes determine uniformity of the product. The increase in mass of the test specimen expressed as a percentage of its dry mass after immersion in water for a specified period of time is determined. The test was carried out according to ASTM C1185. Each specimen was dried to constant weight in a ventilated oven at a temperature of 90±2° C. and cooled to room temperature in a desiccator before being weighed. Then the specimens were submerged for 48±8 h in clean water at 23±3° C. Each specimen was then removed from the water, wiped with a damp cloth, and weighed. i.e. the water absorption percentage is:

[(Wₛ−W_{d})/W_{d}]×100 (3)

Where; Ws is weight of saturated specimen in grams and Wd is weight of dry specimen in grams.

Moisture Content

The percentage of moisture content of the fiber-cement product when conditioned at 50±5% RH and a temperature of 23±2° C. was determined according to ASTM C1185. The test specimen from the flexural test was used for this test. After equilibrium conditioning, each specimen is weighed (w). Each specimen is then dried to constant mass in a circulated oven at a temperature of 90±2° C. and cooled to room temperature in a desiccator and the final mass when oven-dried (F) is recorded. Moisture content percent is given by:

M=100×[(W−F)/F] (4)

SEM

The JEOL JSM-6060 LV SEM model was used. The specimens were mounted on stubs and were gold coated using the sputter coater to enhance conductivity. The specimen was then put in the vacuum chamber in the SEM machine and images were taken with different magnifications from the selected specimens from each of the groups prepared. The fractured surfaces of selected specimens were carefully studied under different magnifications to determine bonding between fibers and other ingredients.

According to relevant standards, cement composite board should meet the standards requirements. So instead of comparing the results of this innovation with other art, it is preferred to point out the characteristics of this products.

The flexural strength for all the samples is between 12-18 MPa All samples are flexible and have a good deflection. They don't have any brittle behaviour. It means these samples have a good toughness.

The results of moisture movement for all samples were less than 0.1%. The results of moisture content for all samples were less than 5%.

The results of water absorption for all samples were less than 4%.

SEM observation was carried out only to identify microstructures of cement composite boards.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A composite cement board composition consisting of:
a compound selected from a group of polymers containing natural/synthetic polymers;
a waste cardboard pulp paper;
cement;
nano calcium silicate;
lime stone powder; and
polymeric admixtures.

2. The composite cement board composition according to claim 1, wherein the compound selected from the group of polymers containing natural or synthetic polymers is acrylic fiber.

3. The composite cement board composition according to claim 1, wherein the waste cardboard pulp paper is a Kraft pulp.

4. The composite cement board composition according to claim 1, wherein the cement is a Portland cement binder.

5. The composite cement board composition according to claim 1, wherein, the nanosilicate is in amorphous form.

6. The composite cement board composition according to claim 1, wherein, the polymeric admixtures includes antifoam, viscose liquid, emulsion polymers and viscosity modifiers.

7. The composite cement board composition according to claim 1, wherein the natural and/or synthetic fibers is present in a range of 3%-12% by weight.

8. The composite cement board composition according to claim 1, wherein the Portland cement binder is present in a range of 60%-75% by weight.

9. The composite cement board composition according to claim 1, wherein the nano calcium silicate is present in a range of 1%-4% by weight.

10. The composite cement board composition according to claim 1, wherein the acrylic fibers is present in a range of 1%-4% by weight.

11. The composite cement board composition according to claim 1, wherein the lime stone powder is present in a range of 5%-20% by weight.

12. The composite cement board composition according to claim 1, wherein the nano calcium silicate particles are less than 100 nanometer in size.

13. The composite cement board composition according to claim 1, wherein the antifoam is a silicone based defoamer.

14. The composite cement board composition according to claim 1, wherein the defoamer is an acetylenic-modified polysiloxane-based defoamer or a paraffinic defoamer.

15. The composite cement board composition according to claim 1, wherein viscosity modifier containing Polyacrylamide viscosity modifier is Nalco 7768.

16. The composite cement board composition according to claim 1, wherein the viscosity modifier includes hydroxyethyl cellulose.

17. A process of preparing a composite cement board consisting of:
selecting a compound from a group of polymers containing natural/synthetic polymers;
selecting Portland cement binder (60% and 75% by weight),
natural and/or synthetic fibers (3% and 12% by weight), nano calcium silicate (1% and 4% by weight), acrylic fibers (1% and 4% by weight) and lime stone powder in (5% and 20% by weight) and some polymeric additives;
obtaining Kraft pulp from waste cardboard and acrylic fibers;
mixing the acrylic fibers with the cement, the nano silicate, the lime stone powder and water using a turbo mixer and a hatcheck machine to prepare a sample;
putting the sample and the mix in an oven at 50 degree of Celsius and 85% relative humidity (RH) for about 8 hours to preheat and pretreat the sample;
transporting the heat treated sample to a storage space with temperature 20-25° C. and 80% RH for 27 days for casting the sample.

18. The process of preparing a composite cement board according to claim 17 further comprises:
smashing scrap cardboard and submerging it into water to obtain cellulose fibres pulp;
fibrillating the obtained cellulose fibers by putting into a refiner;
blending of the refined cellulose fibers and acrylic fibers in a mixer with water; and
putting both the cellulose fibers and acrylic fibers in a turbo mixer adding cement, nanosilicate and lime stone powder to the mixer to create slurry solution.

19. The process of preparing a composite cement board according to claim 17, wherein the acrylic fiber is washed by warm water (about 40° C.).

20. The process of preparing composite cement board according to claim 17, wherein the Nanosilicate has an average particle diameter less than 100 nm.

21. The process of preparing a composite cement board according to claim 17, wherein the addition of slake lime particles improves the modification of the composite microstructure by filling the interstitial space of composite and enhancing the pozzolanic reaction of nano-silica.
